(19) United States
(12) Patent Application Publication
(10) Pub. No.: US 2017/0334416 A1
(43) Pub. Date: Nov. 23, 2017

(54) BRAKE SYSTEM INCLUDING PEDAL SIMULATOR

(71) Applicant: MANDO CORPORATION, Pyeongtaek-si (KR)

(72) Inventors: Dong-Yo RYU, Seongnam-si (KR); Sang-Soo HAN, Seongnam-si (KR)

(21) Appl. No.: 15/600,119

(22) Filed: May 19, 2017

(30) Foreign Application Priority Data
May 20, 2016 (KR) 10-2016-0061921

(51) Int. Cl. B60T 8/40; B60T 7/04; B60T 11/20

(52) U.S. Cl. CPC B60T 8/409; B60T 8/4081; B60T 7/042; B60T 7/04; B60T 11/20

(57) ABSTRACT

According to an embodiment, it provides a brake system comprising a pedal simulator connected to a master cylinder and configured to provide a driver with a pedal feeling upon receiving a hydraulic pressure in accordance with a driver's pedal force, wherein the pedal simulator comprises: a damping housing having an air chamber, installed at a block having a bore communicating with an oil hole connected to the master cylinder, and configured to seal the bore; a reaction force unit configured to provide a pedal reaction force by being compressed by oil introduced through the oil hole; and a check valve disposed in a passage through which the air chamber communicates with the external air.

### CROSS-REFERENCE TO RELATED APPLICATION(S)

This application claims the benefit of Korean Patent Application No. 10-2016-0061921, filed on May 20, 2016 in the Korean Intellectual Property Office, the disclosure of which is incorporated herein by reference.

### BACKGROUND

### 1. Field

Embodiments of the present disclosure relate to a pedal simulator, and more particularly, to a brake system including a pedal simulator that provides an improved pedal feeling during the operation of braking and enables stable operation of a brake pedal.

### 2. Description of the Related Art

In general, vehicles are essentially equipped with a brake system for braking. Recently, systems that electrically control a hydraulic pressure for braking transferred to a wheel cylinder installed at a wheel have been suggested to obtain a stronger and more stable braking force.

When a driver pushes a pedal, such electronic brake systems perform the braking operation by sensing the push using an electronic control unit (ECU), operating a hydraulic pressure generator, and transferring a hydraulic pressure to a wheel cylinder installed at each wheel.

A pedal feeling simulating apparatus (hereinafter, referred to as ‘pedal simulator’) is installed at the electronic brake system to provide a driver with a pedal feeling during braking. An example of the pedal simulator is disclosed in Korean Patent No. 10-0657576. According to the disclosed document, the pedal simulator uses a plurality of springs and a plurality of rubber dampers to provide a reaction force similar to a pedal simulator of conventional brake systems. That is, the pedal simulator provides a pedal reaction force by pressing a piston using oil discharged from a master cylinder in accordance with a pedal force of a brake pedal and compressing the plurality of springs and rubber dampers. These pedal simulators are classified into an oil-filled type in which a simulator chamber provided with a plurality of springs and a plurality of rubber dampers is filled with oil and connected to a reservoir and an air-filled type in which a simulation chamber is filled with air.

However, in the case of the air-filled type pedal simulator, when oil leaks through a piston seal provided between a piston and a simulation chamber and is accumulated in the simulation chamber by a predetermined amount or more, the oil cannot be discharged therefrom leading to failure in a backward operation of a piston. Thus, the driver cannot control the pedal.

In addition, when an internal pressure of the simulation chamber is equal to or greater than a predetermined level due to an increase in temperature or ambient temperature of the electronic brake system, air contained in the simulation chamber may expand and flow into a hydraulic pressure circuit of the electronic brake system through the piston seal. Thus, an appropriate pedal feeling cannot be provided resulting in an increase in the risk of traffic accidents due to sudden braking or failure in braking.

### RELATED ART

Patent Document: Korean Patent No. 10-0657576 (Mando Corporation, Registered on Dec. 7, 2006)

### SUMMARY

Therefore, it is an aspect of the present disclosure to provide a brake system including a pedal simulator that stably controls a brake pedal and stably provides a pedal feeling even when oil is accumulated in a chamber due to a leakage of oil or a pressure of the chamber increases due to an increase in temperature.

Additional aspects of the disclosure will be set forth in part in the description which follows and, in part, will be obvious from the description, or may be learned by practice of the disclosure.

According to an embodiment, it provides a brake system comprising a pedal simulator connected to a master cylinder and configured to provide a driver with a pedal feeling upon receiving a hydraulic pressure in accordance with a driver's pedal force, wherein the pedal simulator comprises: a damping housing having an air chamber, installed at a block having a bore communicating with an oil hole connected to the master cylinder, and configured to seal the bore; a reaction force unit configured to provide a pedal reaction force by being compressed by oil introduced through the oil hole; and a check valve disposed in a passage through which the air chamber communicates with the external air.

Also, according to an embodiment, the check valve is opened to discharge oil or air to the outside when oil is accumulated in the air chamber by a predetermined amount or more due to a leakage of oil through the reaction force unit or an internal pressure is equal to or greater than a predetermined level.

Also, according to an embodiment, the damping housing is installed at the bottom of the block.

Also, according to an embodiment, the check valve comprises an opening/closing member configured to open or close a flow channel communicating with the passage and the check valve is installed to allow the opening/closing member to open or close the flow channel by own weight thereof.

Also, according to an embodiment, the check valve comprises an opening/closing member configured to open or close a flow channel communicating with the passage and an elastic member configured to elastically support the opening/closing member.

Also, according to an embodiment, the damping housing comprises a flange bent to be installed at the block, and a sealing member is disposed between the flange and the block.

Also, according to an embodiment, the reaction force unit comprises: a first reaction piston slidably installed in the bore; a first damping member installed at the first reaction piston to move simultaneously with the first reaction piston; a second reaction piston slidably installed in the air chamber; a support member installed on the bottom surface of the damping housing to be spaced apart from the second reaction piston at a predetermined distance; a reaction spring installed between the second reaction piston and the support member and compressed by the second reaction piston; and a second damping member supported by the support member to be brought into contact with the second reaction piston.

Also, according to an embodiment, a piston seal is disposed between the first reaction piston and the bore.

Also, according to an embodiment, the second reaction piston comprises a protruding part protruding into the bore and a pressing part extending from a lower end of the protruding part into the inside of the damping housing.

According to an embodiment, it provides a brake system comprising a pedal simulator connected to a master cylinder and configured to provide a driver with a pedal feeling upon receiving a hydraulic pressure in accordance with a driver's pedal force, wherein the pedal simulator comprises a damping housing configured to seal a bore, an air chamber formed in the damping housing, and a reaction force unit configured to provide a pedal reaction force by being pressed by oil introduced through an oil hole, and the pedal simulator further comprises a block having the bore communicating with the oil hole connected to the master cylinder; and a check valve disposed in a passage through which the air chamber communicates with the external air.

Also, according to an embodiment, the check valve is opened to discharge oil or air to the outside when oil is accumulated in the air chamber by a predetermined amount or more due to a leakage of oil through the reaction force unit or an internal pressure is equal to or greater than a predetermined level.

Also, according to an embodiment, the damping housing is installed on the bottom surface of the block.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a pedal simulator constituting a brake system according to an embodiment of the present disclosure.

FIG. 2 is a view showing a first-order reaction force generating state of a pedal simulator constituting a brake system according to an embodiment of the present disclosure.

FIG. 3 is a view showing a state of generating a second reaction force of a pedal simulator constituting a brake system according to an embodiment of the present disclosure.

FIG. 4 is a view showing a state in which a check valve provided in a pedal simulator constituting a brake system according to an embodiment of the present disclosure is opened and an air chamber and an outside air are communicated with each other.

### DETAILED DESCRIPTION

Reference will now be made in detail to the embodiments of the present disclosure, examples of which are illustrated in the accompanying drawings, wherein like reference numerals refer to like elements throughout. The present disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. The drawings may be exaggerated, omitted, or schematically illustrated for convenience of description and clarity.

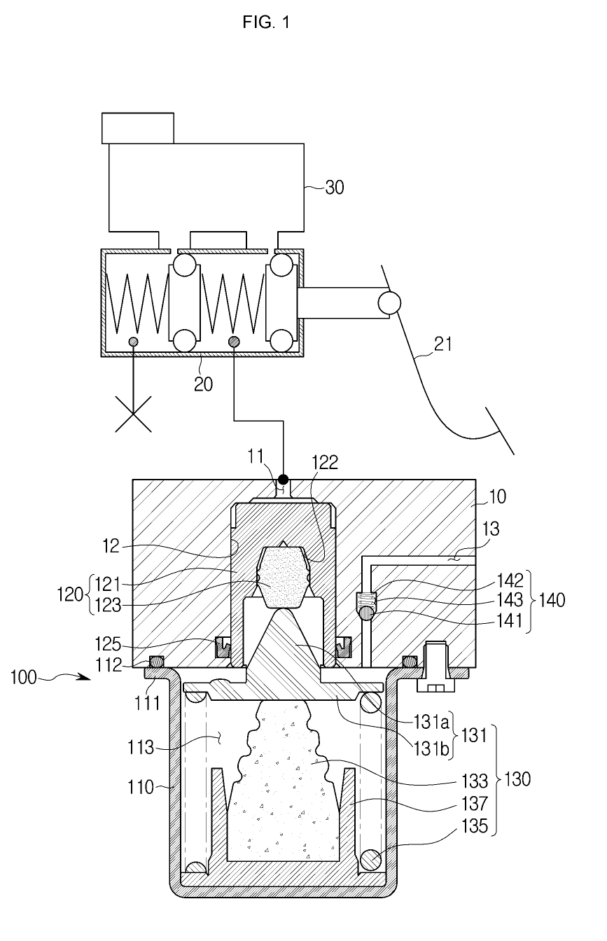

FIG. 1 is a view illustrating a pedal simulator constituting a brake system according to an embodiment of the present disclosure.

Referring to FIG. 1, a pedal simulator 100 constituting a brake system according to an embodiment provides a pedal feeling by oil received from a master cylinder 20 that generates a hydraulic pressure for braking in accordance with a pedal force of a brake pedal 21. The pedal simulator 100 includes a damping housing 110 installed at a block 10 having a bore 12 communicating with an oil hole 11 connected to the master cylinder 20 and having an air chamber 113, a reaction force unit configured to provide a pedal reaction force by being compressed by oil introduced through the oil hole, and a check valve 140 disposed in a passage 13 through which the air chamber 113 communicates with the external air.

In this regard, the reaction force unit includes a first reaction force unit 120 disposed in the bore 12 of the block 10 and configured to provide a pedal reaction force by being pressed by oil introduced through the oil hole 11, and a second reaction force unit 130 disposed in the air chamber 113 and configured to provide a pedal reaction force by being compressed by the first reaction force unit 120.

The block 10 has the oil hole 11 through which a hydraulic pressure is introduced from the master cylinder 20 coupled to a reservoir 30 at an upper portion thereof and the bore 12 communicating with the oil hole 11. The bore 12 formed in the block 10 is a space where the first reaction force unit 120 to be described below is disposed. In addition, the block 10 has the passage 13 such that the air chamber 113 of the damping housing 110 to be described later communicates with the external air, and the check valve 140 is disposed in the passage 13. A structure in which the air chamber 113 communicates with the external air through the passage 13 in accordance with the operation of the check valve 140 will be described below in more detail. The damping housing 110 is coupled to the block 10 at a position corresponding to the bore 12 and seals the bore 12.

The damping housing 110 is provided to form the air chamber 113 therein, seals the bore 12, and is fixed to the block 10. Referring to the drawings, the damping housing 100 is installed such that the air chamber 113 is disposed under the bore 12, and the second reaction force unit 130 which will be described later is disposed in the air chamber 113. Thus, the first reaction force unit 120 and the second reaction force unit 130 are aligned in series. In addition, the damping housing 110 is provided with a flange 111 whose ends are bent for easy installation thereof at the block 10. The flange 111 may be fixed to the block 10 in contact therewith by using a coupling unit such as a bolt. In this regard, a sealing member 112 is disposed between the flange 111 and the block 10 to seal the air chamber 113.

The first reaction force unit 120 includes a first reaction piston 121 slidably installed in the bore 12 and a first damping member 123 installed to move simultaneously with the first reaction piston 121.

When oil is introduced through the oil hole 11 disposed at an upper portion of the first reaction piston 121, the first reaction piston moves downward. A recessed groove 122 recessed upward from a lower portion of the first reaction piston 121 is provided under the first reaction piston 121. Since the first damping member 123 is installed in the recessed groove 122, the first reaction piston 121 and the first damping member 123 move simultaneously.

The first damping member 123 is formed of an elastically deformable rubber material and is elastically deformed when brought into contact with a second reaction piston 131 which will be described later and pressed thereby to provides a reaction force to the brake pedal 21.

Meanwhile, a piston seal 125 is disposed between the first reaction piston 121 and the bore 12. The piston seal 125 is disposed in tight contact with the first reaction piston 121 to separate the bore 12 from the air chamber 113. Although the piston seal 125 is provided on inner walls of the bore 12 i.e., in a groove formed in the block 10, the embodiment is not limited thereto. Also, a groove may be formed on the first reaction piston 121 and the piston seal 125 may move simultaneously with the first reaction piston 121.

The second reaction force unit 130 includes the second reaction piston 131 slidably provided in the air chamber 113, a support member 137 installed on the bottom surface of the damping housing 110 to be spaced apart from the second reaction piston 131 at a predetermined distance, a reaction spring 135 installed between the second reaction piston 131 and the support member 137 and compressed by the second reaction piston 131, and a second damping member 133 installed at the support member 137 to be brought into contact with the second reaction piston 131.

The second reaction piston 131 is provided to be spaced apart from the first reaction piston 121 at a predetermined distance. More particularly, the second reaction piston 131 is disposed at a position facing the recessed groove 122 of the first reaction piston 121 and includes a protruding part 131a protruding toward the first damping member 123 and a pressing part 131b radially extending outwards from a lower end of the protruding part 131a.

The protruding part 131a protrudes toward the bore 12 to be disposed in the first reaction piston 121 in contact with the first damping member 123 as illustrated herein.

The pressing part 131b is disposed in the air chamber 113 in contact with the second damping member 133 on the bottom thereof and supports an upper end of the reaction spring 135. The bottom surface of the pressing part 131b has stepped edges to stably support the reaction spring 135 and the center of the pressing part 131b has a flat shape to press the second damping member 133.

The reaction spring 135 is formed in a coil shape such that an upper end thereof is supported by the second reaction piston 131 and a lower end is supported by the support member 137. When the second reaction piston 131 moves, the reaction spring 135 is compressed and provides the brake pedal 21 with a reaction force due to resilience.

The support member 137 is assembled to a lower inner side of the damping housing 110 to be spaced apart from the second reaction piston 131 at a predetermined distance as described above. The support member 137 has an open top to form an accommodation space in which the second damping member 133 is installed.

The second damping member 133 is formed of an elastically deformable rubber material and disposed in contact with the second reaction piston 131. When pressed by the second reaction piston 131, the second damping member 133 is elastically deformed and provides a reaction force to the brake pedal 21.

Meanwhile, although the second damping member 133 is exemplarily described as being in contact with the second reaction piston 131 before generating a braking force, the present embodiment is not limited thereto. The second reaction piston 131 and the second damping member 133 may be spaced apart from each other. That is, the second reaction piston 131 may contact with the second damping member 133 after moving downward by a predetermined distance.

Also, the second damping member 133 may have a hardness equal to or greater than that of the first damping member 123. This is intended to provide proper pedal feelings in braking by dividing a stroke section of the brake pedal 21 into an initial section and a terminal section. For example, when the second damping member 133 has a lower hardness than that of the first damping member 123, the second damping member 133 provides a weaker reaction force. Thus, while a proper pedal feeling may be provided during the initial stroke section, a poor pedal feeling may be provided during the terminal section. On the contrary, when the second damping member 133 has a hardness equal to or greater than that of the first damping member 123, a weaker reaction force is provided during the initial state, but a stronger reaction force is provided during the terminal section, thereby improving the pedal feeling.

The check valve 140 is disposed in the passage 13 through which the air chamber 113 communicates with the external air. More particularly, the check valve 140 includes an opening/closing member 141 configured to open or close a flow channel 143 communicating with the passage 13 and an elastic member configured to elastically support the opening/closing member 141. The opening/closing member 141 may be a ball type or a plunger type provided to close the flow channel 143. The check valve 140 is provided to solve the problem that adversely affects the operation of the brake pedal 21 and the pedal feeling when oil introduced through the oil hole 11 from the master cylinder 20 leaks into the air chamber 113 or an internal pressure of the air chamber increases by a predetermined level or greater according to external environments. That is, the check valve 140 is opened to discharge oil or air to the outside when oil is accumulated in the air chamber 113 by a predetermined amount or more due to a leakage of oil through the piston seal 125 disposed between the first reaction piston 121 and the bore 12 or an internal pressure of the damping housing 110 is equal to or greater than a predetermined level.

Meanwhile, although the check valve 140 includes the opening/closing member 141 and the elastic member 142 referring to the drawings, the embodiment is not limited thereto. The check valve 140 may include only the opening/closing member 141 such that the opening/closing member 141 closes the flow channel 143 by its own weight.

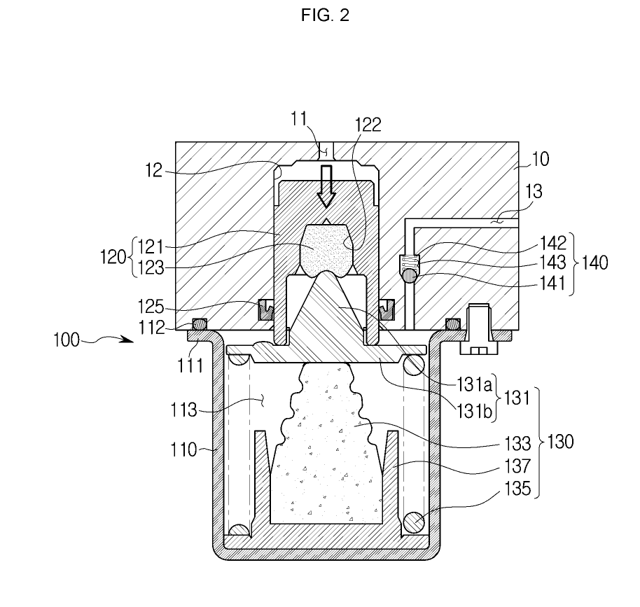

Next, operation states of the above-mentioned pedal simulator will be described with reference to FIGS. 2 to 4.

First, as illustrated in FIG. 2, when a hydraulic pressure is transmitted by oil introduced through the oil hole of the block 10 from the master cylinder (refer to 20 of FIG. 1) by a user's push of the pedal (refer to 21 of FIG. 1), the first reaction piston 121 is pushed and moves simultaneously with the first damping member 123. In this case, the first damping member 123 is brought into contact with the second reaction piston 131 and a reaction force is generated as the first damping member 123 is pushed by the second reaction piston 131.

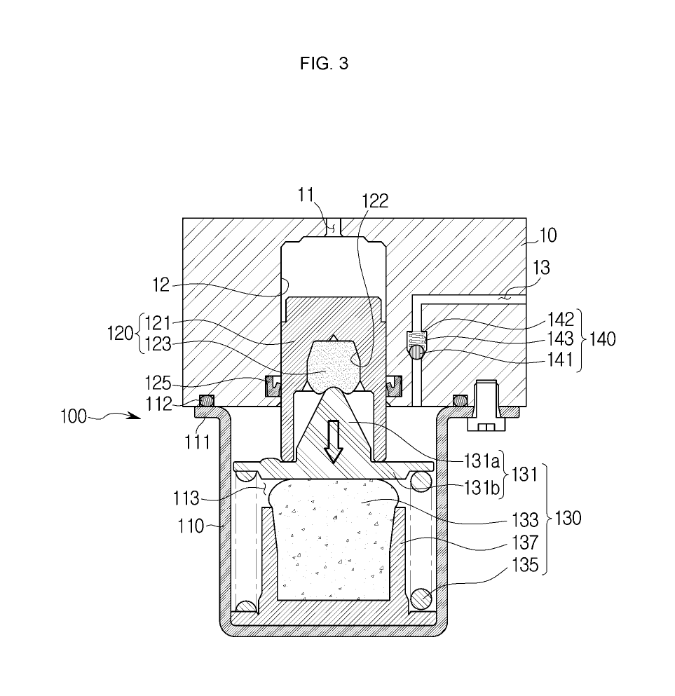

In addition, as illustrated in FIG. 3, when the first reaction piston 121 moves and is brought into contact with the second reaction piston 131 at the bottom thereof, the second reaction piston 131 is pushed to compress the reaction spring 135, thereby generating a pedal reaction force. In addition, as the second damping member 133 in contact with the bottom of the second reaction piston 131 is pushed, an additional pedal reaction force is generated. That is, since pedal reaction forces are generated sequentially by the first reaction force unit 120 and the second reaction force unit 130, a reaction force similar to those of conventional brake systems (CBS) may be provided to the driver.

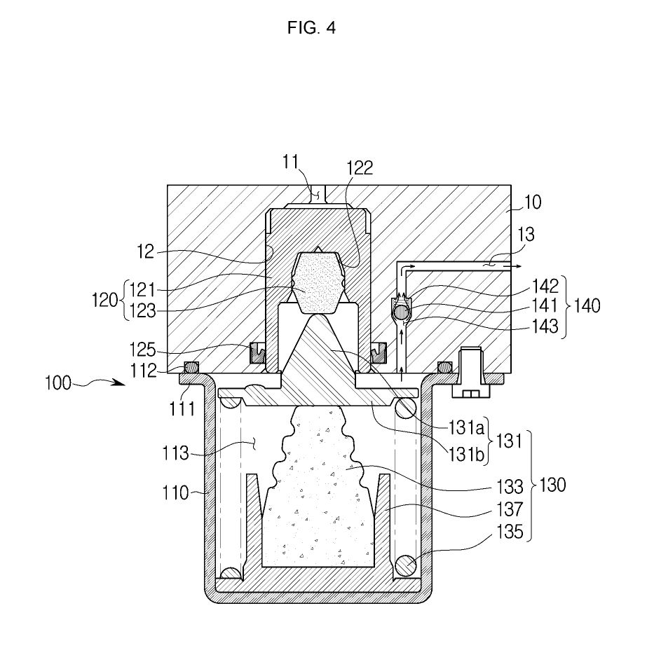

Meanwhile, when leaked oil is accumulated in the air chamber 113 of the pedal simulator 100 by a predetermined amount or more or when an internal pressure of the air chamber 113 increases to a predetermined level or greater, the check valve 140 is opened to discharge oil or air to the outside through the passage 13. For example, FIG. 4 illustrates a state where air is discharged to the outside from the air chamber 113 through the check valve 140. Referring to FIG. 4, when the pressure of the air chamber 113 increases by the predetermined level or greater, the air contained in the air chamber 113 expands. Thus, the opening/closing member 141 of the check valve 140 is opened by the pressure of the air chamber 113, and the air is discharged from the air chamber 113 to the outside through the passage 13. When the pressure of the air chamber 113 decreases after the air is discharged, the opening/closing member 141 closes the flow channel 143 again. Thus, although the pressure of the air chamber 113 increases, the air is discharged to the outside through the passage 13 without flowing into a hydraulic pressure circuit of the brake system through the piston seal 125 disposed between the first reaction piston 121 and the bore 12.

As is apparent from the above description, the brake system including the pedal simulator according to an embodiment of the present disclosure includes the check valve disposed in the passage through which the air chamber communicates with the external air. Thus, when the internal pressure of the air chamber is greater than the predetermined level or oil is accumulated in the air chamber by the predetermined amount or more due to the leakage of oil, the check valve is opened and air or oil is discharged to the outside. Thus, the brake pedal may be stably controlled and the pedal feeling may be provided stably.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A brake system comprising a pedal simulator connected to a master cylinder and configured to provide a driver with a pedal feeling upon receiving a hydraulic pressure in accordance with a driver's pedal force,
wherein the pedal simulator comprises:
a damping housing having an air chamber, installed at a block having a bore communicating with an oil hole connected to the master cylinder, and configured to seal the bore;
a reaction force unit configured to provide a pedal reaction force by being compressed by oil introduced through the oil hole; and
a check valve disposed in a passage through which the air chamber communicates with the external air.

2. The brake system according to claim 1, wherein the check valve is opened to discharge oil or air to the outside when oil is accumulated in the air chamber by a predetermined amount or more due to a leakage of oil through the reaction force unit or an internal pressure is equal to or greater than a predetermined level.

3. The brake system according to claim 1, wherein the damping housing is installed at the bottom of the block.

4. The brake system according to claim 1, wherein the check valve comprises an opening/closing member configured to open or close a flow channel communicating with the passage and the check valve is installed to allow the opening/closing member to open or close the flow channel by own weight thereof.

5. The brake system according to claim 1, wherein the check valve comprises an opening/closing member configured to open or close a flow channel communicating with the passage and an elastic member configured to elastically support the opening/closing member.

6. The brake system according to claim 1, wherein the damping housing comprises a flange bent to be installed at the block, and
a sealing member is disposed between the flange and the block.

7. The brake system according to claim 1, wherein the reaction force unit comprises:
a first reaction piston slidably installed in the bore;
a first damping member installed at the first reaction piston to move simultaneously with the first reaction piston;
a second reaction piston slidably installed in the air chamber;
a support member installed on the bottom surface of the damping housing to be spaced apart from the second reaction piston at a predetermined distance;
a reaction spring installed between the second reaction piston and the support member and compressed by the second reaction piston; and
a second damping member supported by the support member to be brought into contact with the second reaction piston.

8. The brake system according to claim 7, wherein a piston seal is disposed between the first reaction piston and the bore.

9. The brake system according to claim 7, wherein the second reaction piston comprises a protruding part protruding into the bore and a pressing part extending from a lower end of the protruding part into the inside of the damping housing.

10. A brake system comprising a pedal simulator connected to a master cylinder and configured to provide a driver with a pedal feeling upon receiving a hydraulic pressure in accordance with a driver's pedal force,
wherein the pedal simulator comprises a damping housing configured to seal a bore, an air chamber formed in the damping housing, and a reaction force unit configured to provide a pedal reaction force by being pressed by oil introduced through an oil hole, and
the pedal simulator further comprises a block having the bore communicating with the oil hole connected to the master cylinder; and
a check valve disposed in a passage through which the air chamber communicates with the external air.

11. The brake system according to claim 10, wherein the check valve is opened to discharge oil or air to the outside when oil is accumulated in the air chamber by a predetermined amount or more due to a leakage of oil through the reaction force unit or an internal pressure is equal to or greater than a predetermined level.

12. The brake system according to claim 10, wherein the damping housing is installed on the bottom surface of the block.
